(19) United States
(12) Patent Application Publication
(10) Pub. No.: US 2024/0136858 A1
(43) Pub. Date: Apr. 25, 2024

(54) ELECTROMAGNETIC TRANSDUCER CHARGING

(71) Applicant: Cochlear Limited, Macquarie University, NSW (AU)

(72) Inventors: Henrik Fyrlund, Mölnlycke (SE); Armin Azhirnian, Gothenburg (SE)

(21) Appl. No.: 18/546,849

(22) PCT Filed: Feb. 2, 2022
(86) PCT No.: PCT/IB2022/050918

§ 371 Date: Aug. 16, 2023

Related U.S. Application Data
(60) Provisional application No. 63/153,468, filed on Feb. 25, 2021.

(51) Int. Cl. H02J 50/10; H02J 7/00; H04R 1/10

(52) U.S. Cl. CPC H02J 50/10; H02J 7/0042; H04R 1/1025; H04R 2225/31; H04R 2460/13

(57) ABSTRACT

Presented herein are techniques for inductive charging of an electronic device comprising an electromagnetic transducer with an integrated transducer coil. In accordance with embodiments presented herein, the electronic device is configured to use the coil to generate vibration signals and to receive inductive charging signals during inductive charging.

### BACKGROUND

### Field of the Invention

The present invention relates generally to the inductive charging.

### Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In one aspect, an apparatus is provided. The apparatus comprises: at least one rechargeable battery; an electromagnetic transducer comprising a coil; and battery charging circuitry electrically connected to the at least one rechargeable battery and the coil.

In another aspect, a method is provided. The method comprises: generating, with an electromagnetic transducer comprising a coil, vibration signals for delivery to a recipient of an apparatus; receiving inductive charging signals via the coil; and charging at least one rechargeable battery of the apparatus with the inductive charging signals received via the coil.

In another aspect, an apparatus is provided. The apparatus comprises: at least one rechargeable battery; a sound processing module; an amplifier; an electromagnetic transducer comprising a coil; and battery charging circuitry electrically connected between the at least one rechargeable battery and the coil, wherein the battery charging circuitry comprises an alternating current to direct current rectifier, a tuning network electrically connected between the coil and the alternating current to direct current rectifier, and a blocking module, wherein the coil is configured receive an electromagnetic field that induces current flow in the coil, and wherein the battery charging circuitry is configured to use the current flow in the coil to charge the at least one rechargeable battery.

### BRIEF DESCRIPTION OF THE DRAWINGS

Embodiments of the present invention are described herein in conjunction with the accompanying drawings, in which:

FIG. 1A is a schematic diagram illustrating a bone conduction device, in accordance with certain embodiments presented herein;

FIG. 1B is a schematic diagram illustrating another bone conduction device, in accordance with certain embodiments presented herein;

FIG. 2A is a functional block diagram of a bone conduction device, in accordance with certain embodiments presented herein

FIG. 2B is partial cross-sectional view of an electromagnetic transducer, in accordance with embodiments presented herein;

FIG. 3A is a schematic diagram illustrating an inductive charger and a bone conduction device, in accordance with certain embodiments presented herein;

FIG. 3B is a simplified schematic diagram illustrating the inductive charger and the bone conduction device of FIG. 3A, in accordance with certain embodiments presented herein;

FIG. 4 is a schematic diagram illustrating a hearing device, in accordance with certain embodiments presented herein;

FIG. 5 is schematic diagram illustrating an inductive charger and a hearing device, in accordance with certain embodiments presented herein;

FIG. 6 is a schematic diagram illustrating an inductive charger and a bone conduction device, in accordance with certain embodiments presented herein;

FIG. 7A is functional block diagram illustrating a middle ear auditory prosthesis, in accordance with embodiments presented herein;

FIG. 7B is a simplified schematic diagram illustrating an external charger, in accordance with embodiments presented herein; and

FIG. 8 is a flowchart of an example method, in accordance with embodiments presented herein.

### DETAILED DESCRIPTION

Presented herein are techniques for inductive charging of an electronic device comprising an electromagnetic transducer with an integrated transducer coil (coil). In accordance with embodiments presented herein, the electronic device is configured to use the coil to generate vibration signals and to receive inductive charging signals during inductive charging. As used herein, reference to “inductive charging” of an electronic device refers to a process in which the electronic device is inductively provided with power (charging signals) for use by the electronic device in “charging” one or more rechargeable batteries disposed/positioned in (e.g., integrated within) the electronic device.

As described further below, the inductive charger include a charger coil configured to generate the electromagnetic field for transfer of the inductive charging signals to the electronic device. In other embodiments, the inductive charger is configured to use acoustic signals to generate the electromagnetic field for transfer of the inductive charging signals to the electronic device.

Merely for ease of description, the techniques presented herein are primarily described herein with reference to a specific type of electronic device system, namely a bone conduction device. However, it is to be appreciated that the techniques presented herein may also be used to charge a variety of other types of electronic devices, including other types of medical devices. For example, the inductive chargers herein may be used with other hearing devices, such as hearing aids, middle ear auditory prostheses, cochlear implants, direct acoustic stimulators, electro-acoustic prostheses, auditory brain stimulators, etc. The techniques presented herein may also be used with tinnitus therapy devices, vestibular devices (e.g., vestibular implants), visual devices (i.e., bionic eyes), sensors, pacemakers, drug delivery systems, defibrillators, functional electrical stimulation devices, catheters, seizure devices (e.g., devices for monitoring and/or treating epileptic events), sleep apnea devices, electroporation devices, etc. Moreover, it is to be appreciated that the inductive chargers present herein could be used to charge any electronic device having a transducer with an integrated coil, including electronic devices that are not part of a medical device.

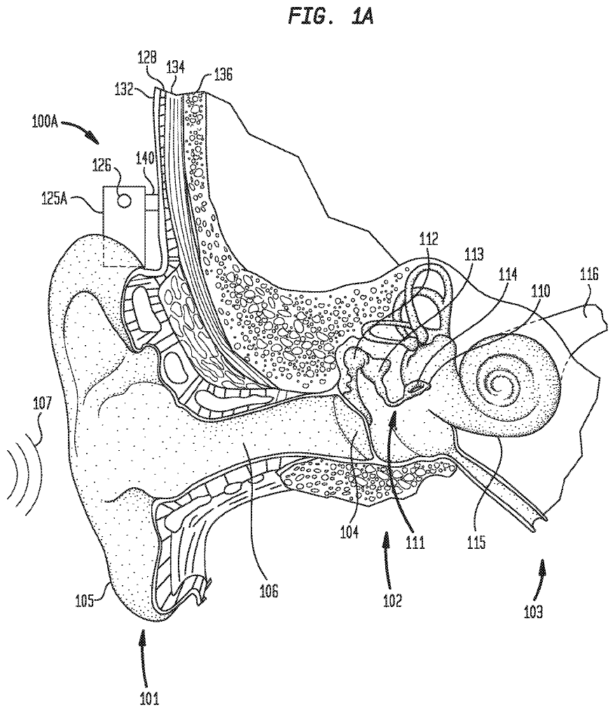

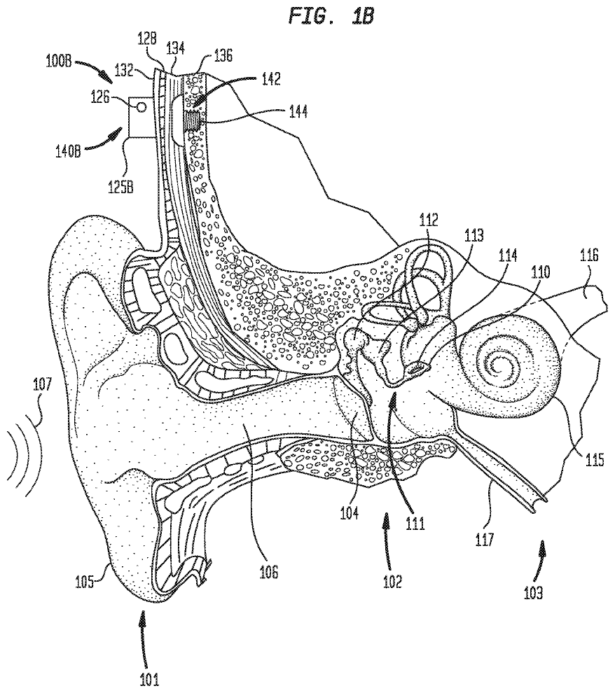

FIG. 1A is a perspective view of a bone conduction device 100A in which certain embodiments presented herein may be implemented. As shown, the recipient has an outer ear 101, a middle ear 102 and an inner ear 103. Elements of outer ear 101, middle ear 102 and inner ear 103 are described below, followed by a description of bone conduction device 100A.

In a fully functional human hearing anatomy, outer ear 101 comprises an auricle 105 and an ear canal 106. A sound wave or acoustic pressure 107 is collected by auricle 105 and channeled into and through ear canal 106. Disposed across the distal end of ear canal 106 is a tympanic membrane 104 which vibrates in response to acoustic wave 107. This vibration is coupled to oval window or fenestra ovalis 110 through three bones of middle ear 102, collectively referred to as the ossicles 111 and comprising the malleus 112, the incus 113 and the stapes 114. The ossicles 111 of middle ear 102 serve to filter and amplify acoustic wave 107, causing oval window 110 to vibrate. Such vibration sets up waves of fluid motion within cochlea 139. Such fluid motion, in turn, activates hair cells (not shown) that line the inside of cochlea 139. Activation of the hair cells causes appropriate nerve impulses to be transferred through the spiral ganglion cells and auditory nerve 116 to the brain (not shown), where they are perceived as sound.

FIG. 1A also illustrates the positioning of bone conduction device 100A relative to outer ear 101, middle ear 102 and inner ear 103 of a recipient of device 100. As shown, bone conduction device 100 is positioned behind outer ear 101 of the recipient and comprises one or more sound input devices 126 to receive sound signals. The sound input elements may comprise, for example, a microphone, telecoil, etc. In an exemplary embodiment, sound input element 126 is a microphone located, for example, on or in bone conduction device 100A. Alternatively, the microphone 126 could be located on a cable extending from bone conduction device 100A, physically separated from the bone conduction device (e.g., an in-the-ear microphone in wireless communication with the bone conduction device), etc.

In an exemplary embodiment, bone conduction device 100A is an operationally removable component configured to be releasably coupled to a bone conduction implant (not shown in FIG. 1A). That is, the bone conduction device 100A can be attached/detached to/from the bone conduction implant by the recipient (or other user) during normal use of the bone conduction device 100A Such releasable coupling is accomplished via a coupling assembly 140 that is configured to mechanically mate with the bone conduction implant.

The bone conduction device 100A includes a housing 125A in which a sound processing module, a transducer/transducer, amplifier, controller, and/or various other electronic circuits/devices are positioned. The transducer may comprise, for example, a vibrating electromagnetic transducer. In operation, the microphone 126 converts received sound signals into electrical signals. These electrical signals are processed by the sound processing module. The sound processing module generates control signals which cause the transducer to vibrate. In other words, the transducer converts the electrical signals into mechanical motion to impart vibrations to the recipient's skull. As such, the bone conduction device 100A is sometimes referred to as a “vibrator unit” or “vibrator,” since it generates vibration for delivery to the skull of the recipient.

As shown in FIG. 1A, the bone conduction device 100A further includes a coupling assembly 140 configured to be removably attached to the bone conduction implant (sometimes referred to as an anchor system and/or a fixation system) implanted in the recipient. In the embodiment of FIG. 1A, the bone conduction implant includes a percutaneous abutment attached to a bone fixture via a screw, where the bone fixture is fixed to the recipient's skull bone 136. The abutment extends from the bone fixture which is screwed into bone 136, through muscle 134, fat 128 and skin 232 so that the coupling assembly 140 may be attached thereto. Such a percutaneous abutment provides an attachment location for the coupling assembly that facilitates efficient transmission of mechanical force (vibration) generated by the bone conduction device 100A. Due to the use of the percutaneous abutment, the bone conduction device 100A is sometimes referred to as a “percutaneous bone conduction device.”

Although FIG. 1A illustrates a percutaneous bone conduction device 100A, it is to be appreciated that certain aspects presented herein may be utilized with other types of bone conduction devices. For example, FIG. 1B is a perspective view of a “transcutaneous bone conduction device” 100B in which embodiments presented herein can be implemented. As described further below, a transcutaneous bone conduction device is a bone conduction device that does not use a percutaneous abutment. Instead, the transcutaneous bone conduction device is held against the skin via a magnetic coupling (e.g., magnetic material and/or magnets being implanted in the recipient and the vibrator having a magnet and/or magnetic material to complete the magnetic circuit, thereby coupling the vibrator to the recipient).

More specifically, FIG. 1B also illustrates the positioning of transcutaneous bone conduction device 100B relative to outer ear 101, middle ear 102 and inner ear 103 of a recipient of device 100. As shown, bone conduction device 100B is positioned behind outer ear 101 of the recipient and comprises a housing 125B having a microphone 126 positioned therein or thereon. Disposed in housing 125B is a magnetic component, a sound processing module, a transducer (e.g., electromagnetic transducer, piezoelectric transducer, etc.), amplifier, and/or various other electronic circuits/devices are positioned. Similar to bone conduction device 100A of FIG. 1A, in FIG. 1B the microphone 126 (e.g., microphone) converts received sound signals into electrical signals. These electrical signals are processed by the sound processing module. The sound processing module generates control signals which cause the transducer to vibrate. In other words, the transducer converts the electrical signals into mechanical motion to impart vibrations to the recipient's skull.

In accordance with the embodiment of FIG. 1B, a fixation system 144 may be used to secure an implantable component 142 to skull 136. As described below, fixation system 144 may be a bone screw fixed to skull 136, and also attached to implantable component 142.

In the arrangement of FIG. 1B, the bone conduction device 100B is a passive transcutaneous bone conduction device. That is, no active components, such as the transducer, are implanted beneath the recipient's skin 132. Instead, the active transducer is located in bone conduction device 140B and the implantable component 142 includes a magnetic plate. The magnetic plate of the implantable component 142 vibrates in response to vibrations transmitted through the skin, mechanically and/or via a magnetic field, that are generated by the magnetic component (plate) in the bone conduction device 100B.

Collectively, FIGS. 1A and 1B illustrate two arrangements of bone conduction devices in which embodiments presented herein may be implemented. However, it is to be appreciated that the embodiments shown in FIGS. 1A and 1B are merely illustrative and that the techniques presented herein may be used in other arrangements. For example, the techniques presented herein could also or alternatively be implemented with “active transcutaneous bone conduction devices” where the transducer is implanted within the recipient (e.g., in implantable component 142). In such arrangements, the a sound processing module may be disposed in an external component and electrical signals representative of the processed sound signals are transcutaneously sent to the implantable component for use in driving the transducer and, as such, generating vibration for delivery to the recipient.

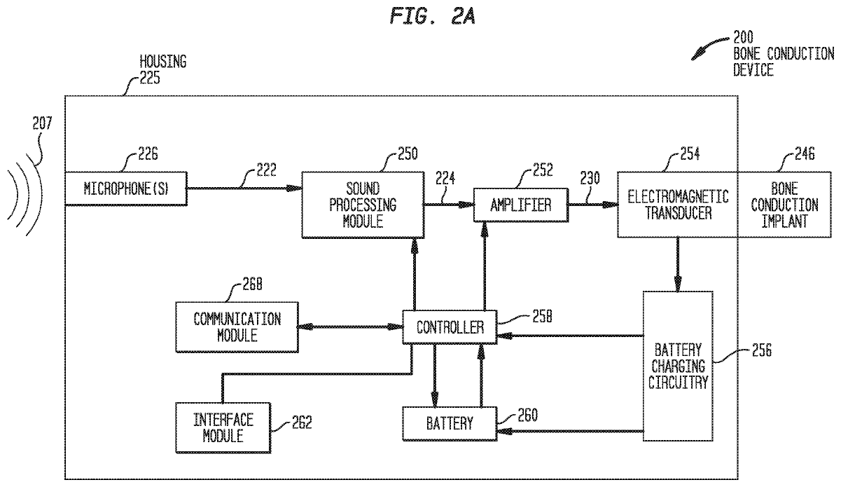

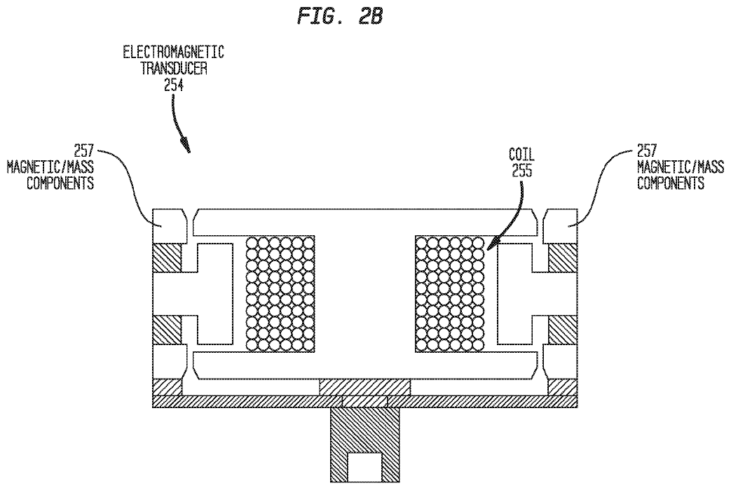

In general, FIGS. 1A and 1B illustrate that bone conduction devices are configured to receive and process sound signals, and to use those sound signals to generate vibrations for delivery to the recipient. FIGS. 1A and 1B correspond to percutaneous and transcutaneous mechanisms, respectively, for delivery of the vibrations to the recipient. FIG. 2A is a functional block diagram illustrating further details regarding how sound signals are used to generate vibrations for delivery to the recipient, in accordance with certain embodiments presented herein, as well as the inductive charging operations presented herein.

More specifically, shown in FIG. 2A is a bone conduction device 200 mechanically or magnetically coupled to a bone conduction implant 246 (representing a percutaneous or transcutaneous vibration delivery mechanism). Bone conduction device 200 comprises a housing 225 and one or more sound input devices, namely microphones 226, disposed in or on the housing 225. The bone conduction device 200 may include additional sound input devices which, for ease of illustration, have been omitted from FIG. 2A.

The bone conduction device 200 also comprises a sound processing module 250, an amplifier 252, an electromagnetic transducer 254, battery charging circuitry 256, a controller (control circuit) 258, at least one rechargeable battery 260, an interface module 262, and a communication module 268. In operation, the microphone(s) 226 are configured to receive sound signals (sound) 207, and to convert the received sound 207 into electrical signals 222. If other sound input devices are present, the sound 207 could also or alternatively may be received by as an electrical signal.

As shown in FIG. 2A, electrical signals 222 are output by microphone 226 to a sound processing module 250. The sound processing module 250 is configured to convert the electrical signals 222 into adjusted/processed electrical signals 224. That is, the sound processing module 250 is configured to apply one or more processing operations (e.g., filtering, noise reduction, automatic gain control/adjustment, loudness compression, etc.) to the electrical signals 222. In certain embodiments, the sound processing module 250 may include a digital signal processor.

The processed electrical signals 224 are provided to the amplifier 252. The amplifier 252 amplifies (i.e., increases the time-varying voltage or current) the processed electrical signals 224 to generate amplified output signals 230. The amplified output signals 230 are then used to drive (activate) the electromagnetic transducer 254 which, in turn, generates corresponding vibrations. That is, using the amplified output signals 230, the electromagnetic transducer 254 generates a mechanical output force that is delivered to the skull of the recipient via bone conduction implant 246. Delivery of this output force causes one or more of motion or vibration of the recipient's skull, thereby activating the hair cells in the cochlea via cochlea fluid motion and, in turn, evoking perception by the recipient of the received sound signals 207.

FIG. 2B is partial-cross sectional view of one arrangement for the electromagnetic transducer 254. FIG. 2B illustrates that the electromagnetic transducer 254 comprises a coil 255, sometimes referred to herein as a “transducer coil.” When used to deliver vibration to the recipient, the transducer coil 255 is driven with the amplified output signals (current signals) 230, where the flow of the current through the transducer coil 255 causes the coil to emit an electromagnetic field. The magnetic field, in turn, causes motion of magnets and mass components 257 (FIG. 2B) within the transducer that results in the vibration delivered to the recipient.

As noted, bone conduction device 200 comprises at least one rechargeable battery 260. The at least one battery 260 provides electrical power to the various components of bone conduction device 200. For ease of illustration, the at least one battery 260 has been shown connected only to the controller 258 and battery charging circuitry 256. However, it should be appreciated that the at least one rechargeable battery 260 may be used to supply power to any electrically powered circuits/components of bone conduction device 200, including sound processing module 250, amplifier 252, electromagnetic transducer 254, etc.

Bone conduction device 200 further includes the interface module 262 that allows the recipient or other user to interact with device 200. For example, interface module 262 may allow the recipient to adjust the volume, alter the speech processing strategies, power on/off the device, etc. Again, for ease of illustration, interface module 262 has been shown connected only to controller 258.

In the embodiment illustrated in FIG. 2A, the components of the bone conduction device 200 (e.g., microphone 226, electromagnetic transducer 254, etc.) have all been shown as integrated into a single housing, referred to as housing 225. However, it should be appreciated that in certain embodiments of the present invention, one or more of the illustrated components may be housed in separate or different housings. Similarly, it should also be appreciated that in such embodiments, direct connections between the various modules and devices are not necessary and that the components may communicate, for example, via wireless connections.

As noted, the at least one rechargeable battery 260 provides power to the other components of bone conduction device 200. The at least one rechargeable battery 260 has a finite capacity (run-time) and, as such, needs to be recharged periodically (e.g., every day, every few days, etc.) so that the bone conduction device 200 can continue to operate. However, the at least one rechargeable battery 260 may be integrated into the bone conduction device 200 (e.g., inside housing 225) in manner such that the battery cannot be removed for these recharging operations (inbuilt rechargeable battery). Accordingly, embodiments presented herein are directed to techniques for inductive charging (recharging) the at least one rechargeable battery 260 while the at least one battery remains within the housing 225. More specifically, as described further below, the embodiments presented herein specifically use the transducer coil 255 (coil in the electromagnetic transducer 254), to inductively receive electrical/inductive charging signals (current signals) for use in charging the at least one battery 260. That is, the transducer coil 255 is used to both generate vibration signals for delivery to the recipient and to inductively receive power for use in recharging the at least one rechargeable battery 260.

Returning to FIG. 2A, as noted above, the bone conduction device 200 includes battery charging circuitry 256 electrically connecting the electromagnetic transducer 254 (e.g., the transducer coil 255 inside the electromagnetic transducer) to the at least one rechargeable battery 260. In operation, the battery charging circuitry 256 is configured to obtain the current induced in the transducer coil 255 inside the electromagnetic transducer 254 and use that current to charge (re-charge) the at least one battery 260. As described further below, the battery charging circuitry 256 is further configured to block amplified output signals 230, thereby ensuring the electromagnetic transducer 254 is also selectively operable to generate vibration for delivery to the recipient.

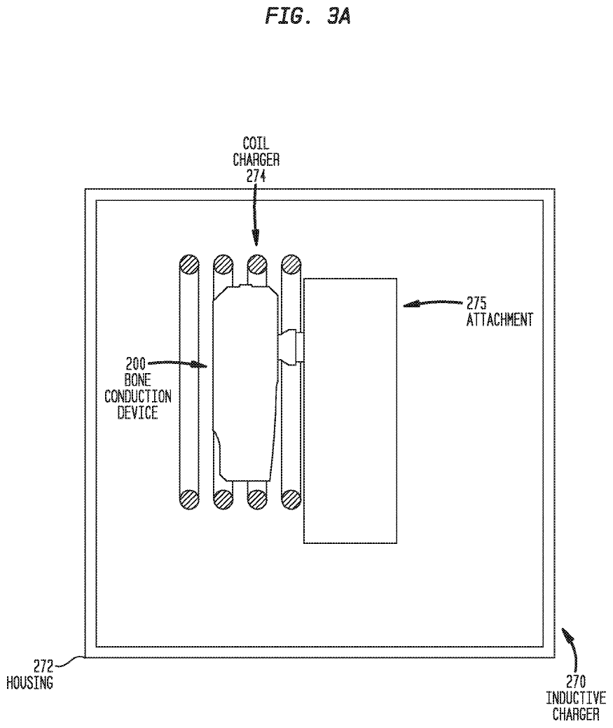

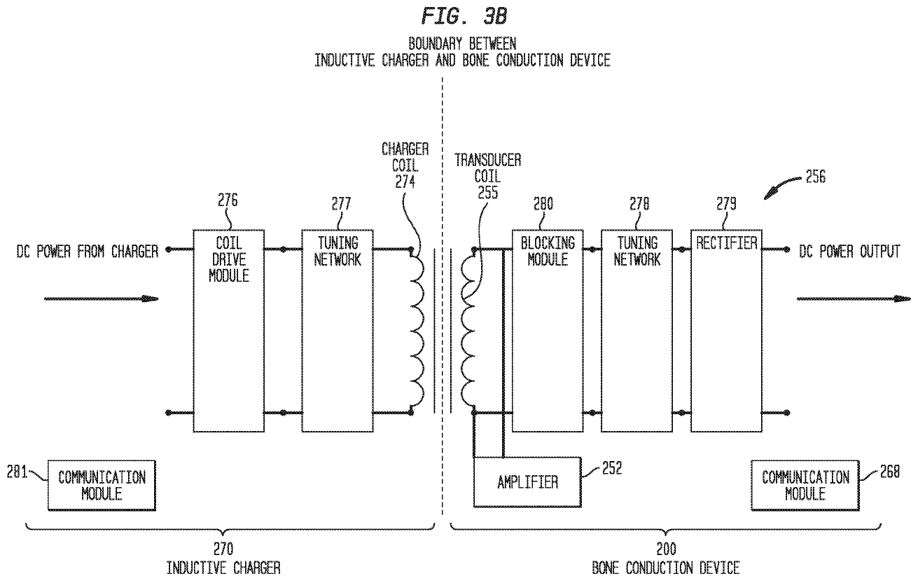

FIG. 3A is a schematic block diagram illustrating the bone conduction device 200 positioned in an inductive charger 270, in accordance with certain embodiments presented herein. FIG. 3B is a simplified schematic circuit diagram of a portion of the bone conduction device 200, namely the transducer coil 255, amplifier 252, and the battery charging circuitry 256, and a portion of the inductive charger 270. For ease of description, FIGS. 3A and 2B will be described together.

In the examples of FIGS. 3A and 3B, the inductive charger 270 comprises a housing 272 configured to receive, and enclose, the bone conduction device 200 therein. For example, the housing 272 of the inductive charger 270 may be formed by a base and a lid mechanically coupled together via a hinge mechanism. When the inductive charger 270 is in a closed arrangement (e.g., the lid is positioned adjacent to the base), the lid and base collectively define the housing 272 having an interior volume that is configured to enclose the bone conduction device 200 therein. FIG. 3A illustrates a cross-sectional view of the inductive charger 270 in a closed arrangement (e.g., enclosing the bone conduction device 200).

The inductive charger 270 comprises a charger coil 274 located within the housing 272. The inductive charger 270 is configured such that, when the bone conduction device 200 is positioned in the housing, the bone conduction device 200 is positioned adjacent to charger coil 274. FIG. 3A illustrates a specific arrangement in which the charger coil 274 is disposed around (e.g., surrounds) a portion of the bone conduction device 200.

FIG. 3A also illustrates that the inductive charger 270 comprises an attachment 275 that is configured to mechanically couple the bone conduction device 200 to the housing 272. In the example of FIG. 3A, the attachment 275 comprises a block with a snap-lock coupling. It is to be appreciated that this specific type of attachment 275 is merely illustrative and that other types of attachments can be used in alternative embodiments. For example, the attachment could also or alternatively comprise a device recess configured (e.g., shaped, sized, etc.) to receive the bone conduction device 200 therein.

During recharging, the bone conduction device 200 may emit vibrations. As such, in certain embodiments, the housing 272 is acoustically sealed and insulated. In addition, the housing 272 can include electromagnetic shielding components to shield/protect electronic devices outside of the housing 272 from the magnetic field generated by the inductive charger 270 during charging.

FIG. 3B illustrates that the inductive charger 270 comprises, among other elements, a coil drive module 276 (e.g., a radio frequency circuit, amplifier, etc.), a tuning network 277 (e.g., one or more capacitors, resistors, etc.), and the charger coil 274. The tuning network 277 is configured to tune the charger coil 274 to resonant at a selected/target frequency for inductive transfer of power. The tuning network 277 and the charger coil 274 are sometimes collectively referred to herein as a “charger resonant circuit.”

FIG. 3B also illustrates that the bone conduction device 200 comprises, among other elements, the transducer coil 255, a tuning network 278 (e.g., one or more capacitors, resistors, etc.), a rectifier 279, a blocking module 280, and the amplifier 252. The tuning network 278 is configured to selectively tune the transducer coil 255 to resonant at the selected/target frequency over which power is inductively transferred from the inductive charger 270. The tuning network 278 and the transducer coil 255 are sometimes collectively referred to herein as a “transducer resonant circuit.” The tuning network 278 and the rectifier 279 form part of the battery charging circuitry 256 of FIG. 2. Although shown as separate elements, the tuning network 278 could be partially or fully integrated in the transducer (e.g., capacitance of the resonant circuit could be controlled by the arrangement of the transducer).

As shown, the coil drive module 276 receives power from a power source, such as an external alternating current (AC) source provided by a wall outlet, a direct current (DC) source provided by one or more batteries, etc. That is, the inductive charger 270 can include one or more batteries therein and/or can include one or more power input ports configured for connection to an external power supply. For example, the inductive charger 270 could include a Universal Serial Bus (USB) input, such as a USB-C power input.

The coil drive module 276 is configured to use the received power to drive the charger coil 274 in a manner that causes the charger coil 274 to emit an electromagnetic field. When the bone conduction device 200 is positioned in the inductive charger 270, the electromagnetic field emitted by the charger coil 274 induces current to flow in the transducer coil 255. The current flowing in the transducer 255 is, in turn, rectified by the rectifier 279 and used to charge/recharge the at least one rechargeable battery 260 (FIG. 2).

In the example of FIGS. 3A and 3B, the presence of the tuning network 278 and the rectifier 279 enable the use of the transducer coil 255 for receipt of the power from the inductive charger 270. In particular, as noted, the tuning network 278 causes the transducer coil 255 to, during charging operations, resonant at the selected/target frequency over which power is inductively transferred from the inductive charger 270. The correct resonant frequency improves the efficiently of power transfer between coils 274 and 255. Additionally, the rectifier 279 converts the induced alternating current (AC) in the transducer coil 255 to a direct current (DC) that can be used to recharge the at least one rechargeable battery 260.

As noted above, and as shown in FIG. 3B, the amplifier 252 is also connected to the transducer coil 255. When delivering vibration to a recipient, the amplifier 252 operates to drive the transducer coil 255 with the amplified output signals 230 so as to induce an electromagnetic field that vibrates (moves) the magnetic/mass components 257 within the transducer 254. The blocking module 280 is present so as to prevent the amplified output signals 230 from being directed into the rectifier 279. That is, the blocking module 280 is configured to block the amplified output signals 230.

In certain embodiments, the blocking module 280 may comprise one or more gates/switches that are closed during recharging operations, but that are otherwise opened to ensure the amplified output signals 230 are directed into the transducer coil 255. In other embodiments, the blocking module 280 may comprise one or more filters (e.g., high-pass filters) that allow the current induced during inductive charging to pass to the rectifier 279, but that block the amplified output signals 230. These two implementations for the blocking module 280 are merely illustrative and it is to be appreciated that other arrangements are possible in alternative embodiments.

In addition to the above, the blocking module 280 is configured to prevent the charging signals (e.g., charging current induced in the transducer coil 255) from reaching the audio output circuitry/stage (e.g., the amplifier 252, etc.), in order to protect the audio output circuitry from power surges. That is, the blocking module 280 can provide bi-directional or two-way blocking of signals, depending on what signals are present at the transducer coil 255. Similar to the above, the blocking module 280 can include one or more switches, gates, or filters that allow the amplified output signals 230 to reach the transducer coil 255 (during normal operations), but that prevent the charging signals from reaching the amplifier 252.

As noted, the bone conduction device 200 includes the communication module 268. The inductive charger 270 also comprises a communication module 281. In operation, the bone conduction device 200 and the inductive charger 270 communicate via the communication modules 268 and 281, respectively, in order to control the inductive charging process. The communication link/channel may be, for example, an acoustic channel (e.g., acoustic waves/sound), a wireless channel (e.g., Bluetooth or Bluetooth Low Energy), a magnetic induction channel, a microwave channel, a radio-frequency channel, an optical channel, etc.

The communication channel between the bone conduction device 200 and the inductive charger 270 is generally used to control the inductive charging process. The communication channel can be used to, for example, communicate battery state/parameters (e.g., battery monitoring information), state of charge, power level regulation parameters, etc. The communication channel is generally a bi-directional (forward/backward) communication link, but could alternatively be a unidirectional link from the bone conduction device 200 to the inductive charger 270.

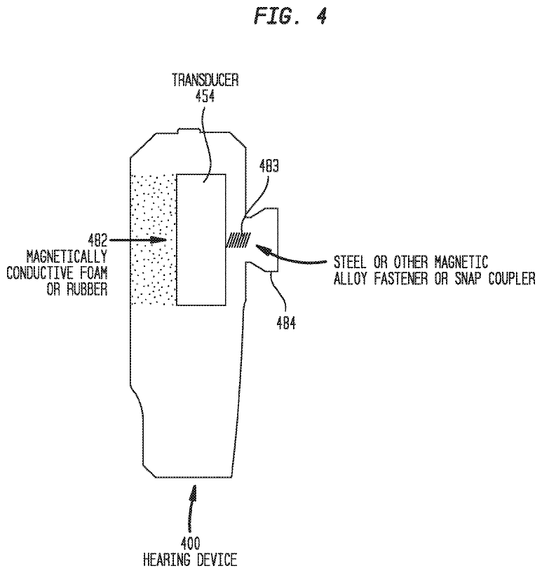

In certain transducer arrangements, the transducer coil may be substantially enclosed in soft magnetic materials and/or may have air gaps between the transducer coil and the device casing. These air gaps, in particular, can make it difficult for the field of the charger coil to penetrate the air without excessively large current in the charging coil. FIG. 4 illustrates a modification to an example hearing device 400 in accordance with embodiments presented herein where a magnetically conductive element 482 (e.g., magnetically conductive foam, magnetically conductive rubber, or other magnetic soft material, magnetic encased liquid, etc.) is positioned between the transducer 454 and the housing 425 of the hearing device 400. In the example of FIG. 4, the hearing device 400 also includes a metal rod 483 extending from a snap-lock coupling 484 through the transducer 454. As such, the magnetically conductive element 482 and the metal rod 483 provide a path for an external electromagnetic field to reach the coil within the transducer 454.

It is to be appreciated that FIG. 4 illustrates one example technique for reducing air gaps within the hearing device 400 and that other techniques are possible. For example, various combinations of soft and/or solid magnetic conductors can be used to forward/direct the electromagnetic field to the coil within the transducer. Alternatively, a hearing or other type of electronic device in accordance with embodiments presented herein can be designed to more directly expose the transducer coil to an external electromagnetic field.

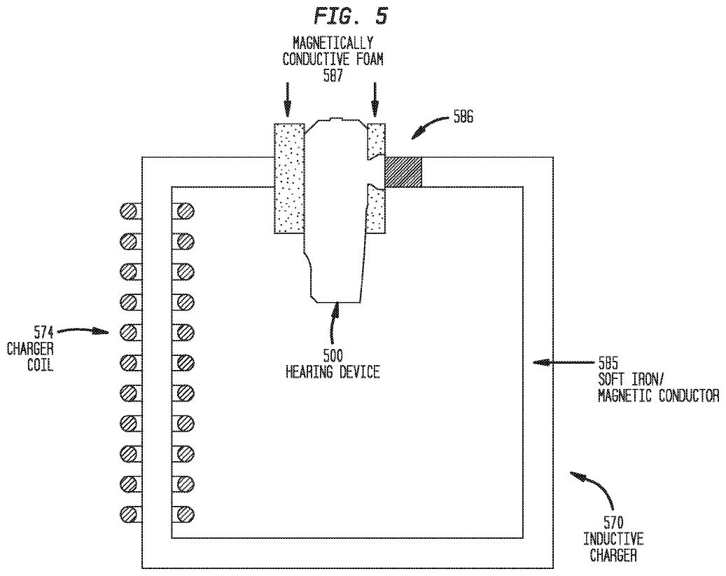

FIG. 5 illustrates a design for an inductive charger 570 that is configured to direct an electromagnetic field to a transducer coil, in accordance with embodiments presented herein. In the example of FIG. 5, the charger coil 574 is disposed around a magnetic core 585 (e.g., iron or other magnetic conductor) that has ends 586 that are adjacent opposing sides of a hearing device 500, when the hearing device 500 is positioned in the inductive charger 570. Disposed between the ends 586 and the hearing device 500 is magnetically conductive foam 587. As such, in the example of FIG. 5, the magnetic core 585 and the magnetically conductive foam 587 direct the electromagnetic field generated by the charger coil 574 through the hearing device 500 and, accordingly, through the transducer coil (not shown in FIG. 5).

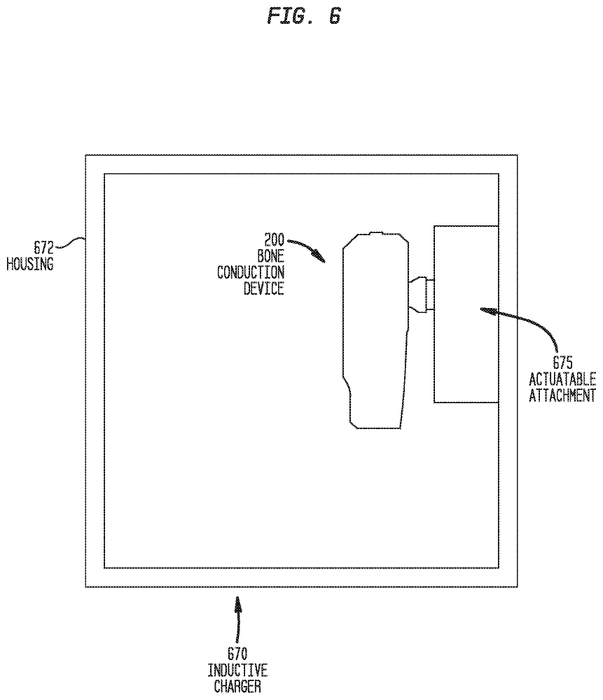

As noted, the techniques presented herein generally use the transducer coil disposed in the transducer of a hearing device, or other electronic device, to generate vibration signals and to inductively receive power via an electromagnetic field. In the above embodiments, the electromagnetic field is generated by a charger coil external to the hearing device. In alternative embodiments, the electromagnetic field can be generated within the hearing device itself via externally induced motion. FIG. 6 illustrates one such example embodiment in accordance with embodiments presented herein.

More specifically, FIG. 6 is a schematic block diagram illustrating the bone conduction device 200 positioned in an inductive charger 670, in accordance with certain embodiments presented herein. In the examples of FIG. 6, the inductive charger 670 comprises a housing 672 configured to receive, and enclose, the bone conduction device 200 therein. For example, the housing 672 of the inductive charger 670 may be formed by a base and a lid mechanically coupled together via a hinge mechanism. When the inductive charger 670 is in a closed arrangement (e.g., the lid is positioned adjacent to the base), the lid and base collectively define the housing 672 having an interior volume that is configured to enclose the bone conduction device 200 therein. FIG. 6 illustrates a cross-sectional view of the inductive charger 670 in a closed arrangement (e.g., enclosing the bone conduction device 200).

The inductive charger 670 comprises an actuatable attachment 675 that is configured to mechanically couple the bone conduction device 200 to the housing 672. In the example of FIG. 6, the actuatable attachment 675 comprises a block with a snap-lock coupling. It is to be appreciated that this specific type of attachment 675 is merely illustrative and that other types of attachments can be used in alternative embodiments.

In operation, the actuatable attachment 675 is configured to vibrate/shake the bone conduction device 200 at an electromechanical resonance frequency. That is, the actuatable attachment 675 is mechanically actuatable/operable to impart motion to the bone conduction device 200 with a specific frequency. The vibration of the bone conduction 200 causes the magnetic components in the bone conduction device to generate an electromagnetic field. The electromagnetic field generated by the magnetic components within the bone conduction 200, in turn, induces current flow in the transducer coil 255 that can be used by the battery charging circuitry 256 to charge the at least one rechargeable battery.

In other words, in the example of FIG. 6, the power is transferred from the inductive charger 670 to the bone conductive device 200 via audio frequency vibrations instead of an externally generated electromagnetic field. However, the transducer coil 255 still receives the power (via the internally generated electromagnetic field) and the battery charging circuitry 256 operates in substantially the same manner as described above with reference to FIGS. 3A and 3B.

During recharging operations of FIG. 6 vibrations are generated and, as such, the housing 672 is acoustically sealed and insulated. In addition, the housing 672 can include electromagnetic shielding components to shield/protect electronic devices outside of the housing 672 from the magnetic field generated by the bone conduction device 200 during charging.

Embodiments have primarily been described above with reference to bone conduction devices with an electromagnetic transducer therein. However, it is to be appreciated that specific reference to a bone conduction device is merely illustrative and that the techniques presented can be implemented with a variety of other hearing devices, other types of medical devices, or other electronic devices having an electromagnetic transducer, with a transducer coil, therein. That is, the techniques presented herein are generally applicable to inductive charging of different types of electronic devices having an electromagnetic transducer and one or more rechargeable batteries.

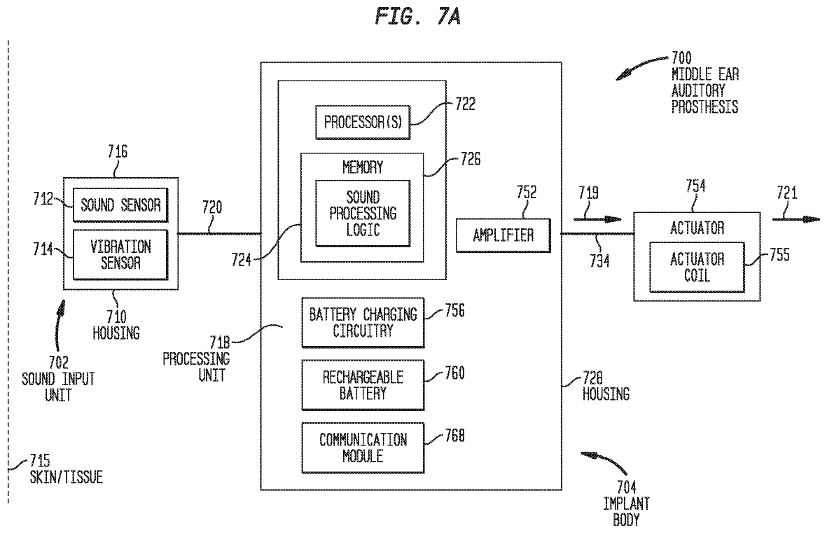

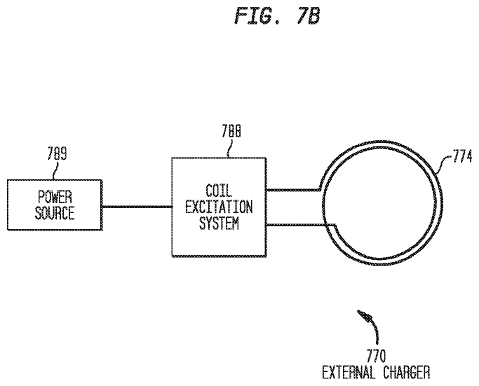

In the above embodiments, the transducer, and transducer coil, are disposed external to a recipient, where the transducer coil is configured to be positioned within an inductive charger. It is also to be appreciated that the techniques presented herein may be implemented with implantable medical devices in which the transducer and one or more rechargeable batteries are implanted in a body of a recipient. FIGS. 7A and 7B illustrate one such example embodiment.

More specifically, FIG. 7A is functional block diagram of a totally implantable middle ear auditory prosthesis 700, in accordance with embodiments presented herein. As shown, the totally implantable middle ear auditory prosthesis 700 is completely/fully implanted under the skin/tissue 715 of a recipient. As such, the totally implantable middle ear auditory prosthesis 700 is configured to operate, for at least a finite period of time, without an external device. As described below, an external device can be used with the totally implantable middle ear auditory prosthesis 700 for inductive charging, for data transfer, etc.

The middle ear auditory prosthesis 700 comprises a sound input module/unit 702, an implant body 704, and a transducer 754, all implanted under the skin/tissue 715 of the recipient. The sound input unit 702 comprises a substantially rigid housing 770, in which at least two implantable sensors 712 and 714 are disposed/positioned. The implantable sensor 712 is configured/designed to pick-up (capture) external acoustic sounds, while implantable sensor 714 is configured/designed to pick-up (capture) vibration caused, for example, by body noises.

The housing 770 is hermetically sealed and includes a diaphragm 716 that is proximate to the microphone 712. The diaphragm 716 may be unitary with the housing 770 and/or may be a separate element that is attached (e.g., welded) to the housing 770. In operation, sound signals that impinge on the skin adjacent to (i.e., on top of) the diaphragm 716 cause the skin adjacent the diaphragm 716, and thus the diaphragm 716 itself, to be displaced (vibrate) in response to the sound signals. The displacement of the diaphragm 716 is detected by the sound sensor 712. In this way, the sound sensor 712, although implanted within the recipient, is able to detect external acoustic sound signals (external acoustic sounds).

In the example of FIG. 7A, the sound sensor 712 and the vibration sensor 714 may each be electrically connected to the implant body 704 (e.g., in a separate casing connected to the main implant body 704). In operation, the sound sensor 712 and the vibration sensor 714 detect input (sound/vibration) signals (e.g., external acoustic sounds and/or body noises) and convert the detected input signals into electrical signals that are provided to the processing unit 718 (e.g., via lead 720). The processing unit 718 is configured to generate stimulation control signals 719 (FIG. 1C) based at least on the external acoustic sounds and/or the vibrations detected by the sound sensor 712 and/or the vibration sensor 714, respectively.

The processing unit 718 comprises at least one processor 722 and at least one memory 724. The memory 724 includes sound processing logic 726 that, when executed by the at least one processor 722, causes the at least one processor 722 to perform sound processing operations described herein (e.g., convert external acoustic sounds and/or the body noises detected by the sound sensor 712 and/or the vibration sensor 714 into stimulation control signals 719). Memory 724 may comprise any suitable volatile or non-volatile computer readable storage media including, for example, random access memory (RAM), cache memory, persistent storage (e.g., semiconductor storage device, read-only memory (ROM), erasable programmable read-only memory (EPROM), flash memory, etc.), or any other computer readable storage media that is capable of storing program instructions or digital information. The processing unit 718 may be implemented, for example, on one or more printed circuit boards (PCBs).

It is to be appreciated that the arrangement for processing unit 718 in FIG. 7A is merely illustrative and that the techniques presented herein may be implemented with a number of different processing arrangements. For example, the sound processing unit 718 may be implemented with processing units formed by any of, or a combination of, one or more processors (e.g., one or more Digital Signal Processors (DSPs), one or more uC cores, etc.), firmware, software, etc. arranged to perform, for example, the operations described herein.

As shown, the implant body 714 includes a hermetically sealed housing 728 in which the processing unit 718 is disposed. Also disposed in the housing 728 is at least one rechargeable battery 760, battery charging circuitry 756, and a communication module 768. As noted above, the processing unit 718 generates stimulation control signals. The stimulation control signals are provided to the amplifier 752 that, in turn, generates amplified output signals 719 delivered to the transducer 754 (e.g., via lead 734) for use in delivering mechanical stimulation signals to the recipient. In FIG. 7A, the mechanical stimulation signals (vibration signals or vibration) delivered to the recipient are represented by arrow 721. The transducer 754 is configured to be implanted in the recipient so as to impart motion to (e.g., vibrate), for example, the ossicles or the cochlea fluid directly via, for example, the oval window, the round window, a cochleostomy, etc.

The at least one rechargeable battery 760 provides power to the other components of the middle ear auditory prosthesis 700. The at least one rechargeable battery 760 has a finite capacity (run-time) and, as such, needs to be recharged periodically (e.g., every day, every few days, etc.) so that the middle ear auditory prosthesis 700 can continue to operate. However, as noted, the rechargeable battery 760 is implanted within the recipient. Accordingly, embodiments presented herein are directed to techniques for inductive charging (recharging) the at least one rechargeable battery 760 while the at least one battery remains within the recipient. More specifically, as described elsewhere herein, the embodiments presented herein specifically use the transducer coil 755 (coil in the electromagnetic transducer 754), to inductively receive electrical charging signals (current signals) for use in charging the at least one battery 760. That is, the transducer coil 755 is used to both generate vibration signals for delivery to the recipient and to inductively receive power for use in recharging the at least one rechargeable battery 760. In the example of FIG. 7A, the battery charging circuitry 756 is similar to battery charging circuitry 256, described above, in that it comprises a tuning network and a rectifier electrically connected to the transducer coil 755. The presence of the tuning network and the rectifier enable the use of the transducer coil 755 for receipt of the power from an external inductive charger, as described below.

FIG. 7B is a block diagram illustrating one example arrangement for an external inductive charger (external charger or inductive charger) 770 which may be in the form of a “pillow charger,” an off-the-ear (OTE) unit, a behind-the-ear ear (BTE) unit, a micro-BTE unit, etc., in accordance with embodiments presented herein. The external charger 770 comprises a coil excitation system 788, a power source (e.g., one or more batteries), and one or more charger coils 774. In general, the coil excitation system 788 comprises, among other elements, a coil drive module (e.g., a radio frequency circuit, amplifier, etc.) and a tuning network (e.g., one or more capacitors, resistors, etc.). The tuning network is configured to tune the coil(s) 774 to resonant at a selected/target frequency for inductive transfer of power.

The coil excitation system 788 receives power from the power source 789. The power source 789 may comprise one or more rechargeable batteries, one or more disposable batteries, or one or more inputs for connection to an external alternating current (AC) source provided by a wall outlet, etc. The coil excitation system 788 is configured to use the received power to drive the charger coil(s) 774 in a manner that causes the charger coil(s) 774 to emit an electromagnetic field. When the middle ear auditory prosthesis 700 is positioned adjacent to the inductive charger 770, the electromagnetic field emitted by the charger coil(s) 774 induces current to flow in the transducer coil 755. The current flowing in the transducer 755 is, in turn, rectified by the rectifier in the battery charging circuitry 756 and used to charge/recharge the at least one rechargeable battery 760 (FIG. 7A), in a similar manner as described above.

That is, in the example of FIG. 7A, the presence of the tuning network and the rectifier in the battery charging circuitry 756 enable the use of the transducer coil 755 for receipt of the power from the external charger 770. In particular, as noted, the tuning network causes the transducer coil 755 to, during charging operations, resonant at the selected/target frequency over which power is inductively transferred from the external charger 770. The correct resonant frequency improves the efficiently of power transfer between coils 774 and 755. Additionally, the rectifier converts the induced alternating current (AC) in the transducer coil 755 to a direct current (DC) that can be used to recharge the at least one rechargeable battery 760.

As noted above, the amplifier 752 is also connected to the transducer coil 755. When delivering vibration to a recipient, the amplifier 752 operates to drive the transducer coil 755 with the amplified output signals 719 so as to induce an electromagnetic field that vibrates (moves) the magnetic/mass components within the transducer 754. The battery charging circuitry 756 also includes a blocking module, as described above, which is configured to prevent the amplified output signals 719 from being directed into the rectifier. That is, the blocking module is configured to block the amplified output signals 719.

As noted, the middle ear auditory prosthesis 700 includes the communication module 768. The inductive charger 770 also comprises a communication module for communication with the middle ear auditory prosthesis 700 to form a communication link/channel between the external charger and the middle ear auditory prosthesis. The communication link/channel may be, for example, an acoustic channel (e.g., acoustic waves/sound), a wireless channel (e.g., Bluetooth or Bluetooth Low Energy), a magnetic induction channel, a microwave channel, a radio-frequency channel, an optical channel, etc., and is generally used to control the inductive charging process.

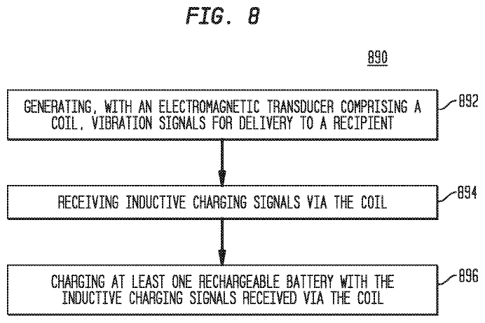

FIG. 8 is a flowchart of a method 890 implemented by an apparatus comprising an electromagnetic transducer, battery charging circuitry, and at least one rechargeable battery, in accordance with embodiments presented herein. Method 890 begins at 892 where the electromagnetic transducer, which comprises a transducer coil, generates vibration signals for delivery to a recipient. At 894, the electromagnetic transducer receives inductive charging signals via the transducer coil. At 896, the battery charging circuitry uses the inductive charging signals received via the transducer coil are used to charge at least one rechargeable battery of the apparatus.

As should be appreciated, while particular uses of the technology have been illustrated and discussed above, the disclosed technology can be used with a variety of devices in accordance with many examples of the technology. The above discussion is not meant to suggest that the disclosed technology is only suitable for implementation within systems akin to that illustrated in the figures. In general, additional configurations can be used to practice the processes and systems herein and/or some aspects described can be excluded without departing from the processes and systems disclosed herein.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and processes to the particular aspects described. Accordingly, additional configurations can be used to practice the methods and systems herein and/or some aspects described can be excluded without departing from the methods and systems disclosed herein.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure. Further, the disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

It is also to be appreciated that the embodiments presented herein are not mutually exclusive and that the various embodiments may be combined with another in any of a number of different manners.

1. An apparatus, comprising:
at least one rechargeable battery;
an electromagnetic transducer comprising a coil; and
battery charging circuitry electrically connected to the at least one rechargeable battery and the coil.

2. The apparatus of claim 1, wherein the coil is configured receive an electromagnetic field that induces current flow in the coil, and wherein the battery charging circuitry is configured to use the current flow in the coil to charge the at least one rechargeable battery.

3. The apparatus of claim 1, wherein the battery charging circuitry comprises a rectifier.

4. The apparatus of claim 3, wherein the battery charging circuitry further comprises a tuning network connected between the rectifier and the coil.

5. The apparatus of claim 1, further comprising an amplifier configured to deliver amplified output signals to the electromagnetic transducer.

6. The apparatus of claim 5, wherein the battery charging circuitry comprises a rectifier and a blocking module connected between the rectifier and the coil, wherein the blocking module is configured to prevent the amplified output signals from reaching the rectifier.

7. The apparatus of claim 6, wherein the blocking module comprises one or more switches configured to be selectively opened or closed to prevent the amplified output signals from reaching the rectifier or one or more filters configured to prevent the amplified output signals from reaching the rectifier.

8. (canceled)

9. The apparatus of claim 7, wherein the one or more filters comprise one or more high-pass filters.

10. The apparatus of claim 6, wherein the blocking module is configured to prevent inductive charging signals from reaching the amplifier.

11. The apparatus of claim 10, wherein the blocking module comprises one or more switches configured to be selectively opened or closed to prevent the inductive charging signals from reaching the amplifier or one or more filters configured to prevent the inductive charging signals from reaching the amplifier.

12. (canceled)

13. The apparatus of claim 1, wherein the apparatus comprises a housing and one or more magnetically conductive elements disposed between the electromagnetic transducer and the housing, wherein the one or more magnetically conductive elements are configured to forward externally-generated electromagnetic fields to the electromagnetic transducer.

14. (canceled)

15. (canceled)

16. (canceled)

17. A system comprising the apparatus of claim 1, and an inductive charger configured to induce current flow in the coil, and wherein the battery charging circuitry is configured to use the current flow in the coil to charge the at least one rechargeable battery.

18. The system of claim 17, wherein the inductive charger comprises a charger coil configured to generate, external to the apparatus, an electromagnetic field that induces the current flow in the coil.

19. The system of claim 18, wherein the inductive charger is configured to direct the electromagnetic field to the coil.

20. The system of claim 17, wherein the inductive charger is configured to vibrate the apparatus at a selected frequency to cause magnetic components in the apparatus to generate an electromagnetic field that induces the current flow in the coil.

21. The system of claim 17, wherein the inductive charger comprises a charging case comprising a housing configured to enclose the apparatus therein.

22. (canceled)

23. (canceled)

24. The system of claim 17, wherein the apparatus is an implantable medical device configured to be implanted in a recipient, and wherein the inductive charger is configured to be worn by the recipient.

25. A method, comprising:
generating, with an electromagnetic transducer comprising a coil, vibration signals for delivery to a recipient of an apparatus;
receiving inductive charging signals via the coil; and
charging at least one rechargeable battery of the apparatus with the inductive charging signals received via the coil.

26. The method of claim 25, wherein receiving inductive charging signals via the coil, comprises:
receiving, at the coil, an electromagnetic field that induces current flow in the coil, and wherein the apparatus comprises battery charging circuitry configured to use the current flow in the coil to charge the at least one rechargeable battery.

27. The method of claim 26, further comprising:
generating the electromagnetic field with a charger coil disposed outside of the apparatus.

28. The method of claim 26, further comprising:
generating the electromagnetic field with the electromagnetic transducer inside the apparatus.

29. The method of claim 28, wherein the electromagnetic transducer comprises one or more magnetic components, and wherein generating the electromagnetic field with the electromagnetic transducer comprises:
vibrating the one or more magnetic components via an externally applied vibration, where vibration of the one or more magnetic components generates the electromagnetic field.

30. The method of claim 26, wherein the current flow in the coil comprises alternating current, and wherein the method further comprises:
rectifying the alternating current with a rectifier in the battery charging circuitry to generate a direct current output.

31. The method of claim 26, further comprises:
selectively tuning the coil to resonant at a predetermined resonant frequency while receiving the inductive charging signals.

32. The method of claim 26, wherein generating the vibration signals for delivery to a recipient of an apparatus, comprises:
generating amplified output signals at an amplifier of the apparatus; and
delivering the amplified output signals to the coil.

33. The method of claim 32, wherein the battery charging circuitry comprises a rectifier and a blocking module connected between the rectifier and the coil, and wherein the method comprises:
preventing, with the blocking module, the amplified output signals from reaching the rectifier.

34. (canceled)

35. (canceled)

36. (canceled)

37. The method of claim 33, further comprising:
preventing, with the blocking module, the inductive charging signals from reaching the amplifier.

38. (canceled)

39. (canceled)

40. The method of claim 25, further comprising:
sending charging control signals from the apparatus to an external charger, wherein the external charger initiates generation of the inductive charging signals.

41. (canceled)
